(19) United States
(12) Patent Application Publication
(10) Pub. No.: US 2009/0250607 A1
(43) Pub. Date: Oct. 8, 2009

(54) METHOD AND APPARATUS TO INCREASE THROUGHPUT OF LIQUID CHROMATOGRAPHY-MASS SPECTROMETRY

(75) Inventors: Sau Lan Tang Staats, Hockessin, DE (US); Andris Suna, Wilmington, DE (US)

Correspondence Address: Leason Ellis LLP, 81 Main Street, Suite 503, White Plains, NY, 10601, US

(73) Assignee: Phoenix S&T, Inc., Chester, PA (US)

(21) Appl. No.: 12/372,151

(22) Filed: Feb. 17, 2009

Related U.S. Application Data
(60) Provisional application No. 61/031,569, filed on Feb. 26, 2008.
(60) Provisional application No. 61/057,432, filed on May 30, 2008.

(51) Int. Cl. H01J 49/26

(52) U.S. Cl. 250/282; 250/288

(57) ABSTRACT

An apparatus according to the present invention includes a plurality of sample spraying devices, each of which connects to an LC column. The apparatus includes an electrical circuit that can turn a high voltage between 1 and 5 KV on and off on the time-scale of nanoseconds to milliseconds. The circuit is controlled by a computer program which applies the high voltage to each spray device in a Hadamard sequence. The spray devices are positioned aiming at the mass spectrometer inlet. The preferred configuration of arrangements for the spray devices are in a circle or an arc of a circle around the inlet of a mass spectrometer.

### CROSS REFERENCE TO RELATED APPLICATIONS

The present application claims the benefit of U.S. patent application Ser. No. 61/031,569, filed Feb. 26, 2008, and U.S. patent application Ser. No. 61/057,432, filed May 30, 2008, each of which is hereby incorporated by reference in its entirety.

### BACKGROUND

Liquid chromatography-mass spectrometry (LC-MS) is a fast growing technique used in the pharmaceutical and biotech industries for a wide variety of applications, from the earliest stage of drug discovery using combinatorial chemistry to drug efficacy testing in clinical trials. Traditionally a single mass spectrometer is interfaced with the output of a liquid chromatography instrument for the measurements. The mass spectrometer gives relatively definitive identification of the analytes eluting from a liquid chromatographic column through mass measurements of the molecules. Such mass measurements may give the molecular formulae of the analytes. Because of the high cost of a mass spectrometer and the rapidly increasing utility of the LC-MS technique, it is desirable to increase the throughput of LC samples into a single mass spectrometer.

At present, the state-of-the-art high throughput LC-MS has eight conventional LC's connecting to a single mass spectrometer for eight simultaneous on-line LC-MS measurements. The eluate from each LC column flows into a stainless steel needle where it is vaporized with the help of both an electric field and a high pressure nebulizing gas such as nitrogen. The eight spray needles are arranged in a circle around the mass spectrometer inlet cone so that each needle is positioned orthogonally from the inlet cone. A circular mechanical device with an opening for the spray to come through rotates around the eight needles so that only the eluate from one LC is allowed to be sprayed orthogonally into the mass spectrometer at a given time while the sprays from the other seven needles are blocked by the rotating device. With this sequential data acquisition method, increasing the number of conventional LC's beyond eight causes the peak (tens of seconds to over a minute in width) in the mass chromatogram to lose resolution and peak definition because of insufficient dwell time on each peak. The mechanical movement of the rotating device also limits how fast the spray can be switched from one needle to the next. In the LC technique called micro- or nano-LC where the LC column is made of silica or polymeric capillaries with inside diameters of 100 μm or smaller, the residence time limitation will be a greater problem since micro-LC or nano-LC peaks can be much sharper (a few seconds to about 30 seconds wide) than conventional LC peaks. Another method in the art is to combine the eluates from multiple columns running the same LC method into a single conduit that is connected to a single spray device that sprays the combined flow into a single mass spectrometer to identify the various peaks. This approach is possible if each sample running in each column contains only a few components, and the practitioner has an independent means to estimate the origin, i.e., from which column, of a particular detected peak in the mass chromatogram of the combined flow. For example, if ultraviolet (UV) spectroscopy is used to detect the chromatographic peaks at the end of each column, this information can be used to correlate the peaks in the mass chromatogram provided that the chemical species of interest can be detected by both UV spectroscopy and mass spectrometry. However, the possibility for ambiguous peak assignment to a particular LC column is high.

In other separation techniques such as gas chromatography (GC) and capillary electrophoresis (CE), a technique known as Hadamard Transform (HT) has been successfully applied to increase sample throughput significantly. A common feature in these application is that a Hadamard pseudorandom sequence made up of “0's” and “1's” is applied to each sample containing multiple components during sample injection or introduction into a single separation column or capillary. The Hadamard sequence is derived from the Hadamard matrix well known in the art. The “1” indicates the “on” state of sample injection time interval, and “0” is the “off” state or the time interval in which no sample injection occurs. As the components in each segment of injected sample traverse down the column or capillary, the components can be tracked back to the sample from which they come. Multiple samples (over a hundred) can be injected (each injected with its own Hadamard sequence i from the set of sequences in their Hadamard matrix) into a single column or capillary. Each sample may also be encoded with a Hadamard sequence j from another Hadamard matrix to tag its identity such that the component k detected at the end of the column after the separation can be traced back to sample j through a deconvolution routine. During the separation, the more mobile components from a sample, e.g., sample j+1, that has been injected after sample j may overtake the slower components in sample j while traversing the column or capillary. However, the deconvolution of the Hadamard sequence allows the conventional chromatogram for each sample to be restored as if each sample has been run sequentially through the column before the next sample is injected. An additional advantage of using Hadamard Transform for sample injection is the noise reduction in the measurements. The signal quality of the chromatographic features could be improved as the number of injections N for each sample becomes large since the signal to noise ratio is proportional to the square root of N.

The Hadamard Transform technique has also been applied to gas phase molecular beam experiments, as well as for improving the signal quality for time-of-flight mass spectrometry. In all of these cases, the Hadamard sequence is applied to each sample before the components in each sample separate according to the different mobilities of the components. In addition, the number of injections is made large (up to thousands) to take advantage of the signal to noise ratio improvement.

For LC, this application of the Hadamard Transform has severe limitations. Unlike GC and CE where the mobile phases (the carrier gas in GC, and the electrolyte in CE) are constant throughout the separation experiments, the most popular and powerful LC methods involve gradient elution, i.e., the mobile phase consists of two components, an organic solvent such as acetonitrile and the aqueous component the relative composition of which change with time. If multiple samples are injected into the sample column sequentially but with a Hadamard sequence for each sample, each sample will experience a different LC run program, i.e., the mobile phase composition at the beginning of the separation is different for each sample. Secondly, for applications in proteomics where a large number of components may be present in each sample, injecting multiple samples in a single column, especially a capillary column with low sample capacity, is not feasible.

### SUMMARY

In one embodiment, the present invention is in the form of an apparatus consisting of multiple sample spraying devices each of which connects to an LC column. The apparatus includes an electrical circuit that can turn a high voltage between 1 and 5 KV on and off on the time-scale of nanoseconds to milliseconds. The circuit is controlled by a computer program which applies the high voltage to each spray device in a Hadamard sequence. In particular, the computer program is software that includes executable code and in the present embodiment, the executable code governs and controls the application of high voltage to each spray device according to the Hadamard sequence.

The spray devices are positioned aiming at the mass spectrometer inlet. The preferred configuration of arrangements for the spray devices are in a circle or an arc of a circle around the inlet of a mass spectrometer. The spray devices are preferably clog resistant and long lasting, and are capable of unassisted electrospray, i.e., no nebulizing gas is used to induce the spray. The plastic nozzle as described in U.S. Pat. No. 6,800,849 (which is hereby incorporated by reference in its entirety) or a capillary with a tapered end and capped with a polymeric porous plug may be suitable. The number N of spray devices in the apparatus is preferred to be a number at which a cyclic Hadamard Simplex matrix (S matrix) of dimension N exists, i.e., N=3, 7, 11, 15 . . . . The cyclic Simplex matrix is well known in the art. The upper limit for n is determined by the width in time of the chromatographic peak, the switching time of the high voltage and the scan time of the mass spectrometer for the mass range of interest such that each N-element Hadamard sequence from the N-dimension cyclic Hadamard S matrix can be applied to the spray devices at least once during the duration of the chromatographic peak, and the physical space available in the circle surrounding the mass spectrometer to accommodate the spray devices. The unique feature of the application of the Hadamard sequence in this fashion is that the Hadamard sequence is not applied to a particular sample, but to the control of the n number of independent spray devices that spray the separated components of n different samples. During any particular time interval in the mass chromatogram, the exact on/off spray pattern of each spray device is known and tracked. Each spray device sprays only during the “on” state of the Hadamard sequence (the “1” state) when the high voltage is applied to the liquid at the tip of the spray device, and stops spraying during “off” state, or “0” state of the sequence. Each spray device is connected to a LC column running a particular separation which may be the same or different from the other LC columns in the apparatus. With this apparatus and the computer control of the high voltage application that controls the on/off of the spray, the number of samples that can be detected by a single mass spectrometer at any time is increased to the number of spray devices. Any mass chromatographic peak in the chromatogram recording all the peaks eluting from all the LC columns can be unambiguously assigned to the column from which it elutes, and thus to the sample of which it is a component. By applying the deconvolution routine to the measured peak, the peak shape and intensity is stored to resemble the peak that would have been obtained when the peak comes from a single LC column the eluate of which is sprayed into the mass spectrometer continuously.

The LC columns in this invention may be free standing columns made of capillaries or conventional stainless steel tubings packed with chromatographic particles or resin, or they may be in the form of a planar microfluidic cartridge having a single packed column or multiple packed columns in the same cartridge. Likewise the separation means may not be in a column format, e.g., open capillaries, two-dimensional separation devices, etc. The spray devices are connected to the ends of planar microfluidic LC columns through flexible capillaries with or without fittings.

### BRIEF DESCRIPTION OF THE DRAWING FIGURES

FIG. 1 is a side elevation view of an apparatus according to one embodiment for simultaneously detecting the eluates spraying from nanospray spray devices from multiple capillary liquid chromatography columns by a single mass spectrometer;

FIG. 2 is a top plan view of an arrangement of spray devices in a circular format where all the spray devices point at the center of the circle;

FIG. 3 is a perspective view of another arrangement of the spray devices in a circular format where the spray devices are pointing along lines parallel to the axis joining the mass spectrometer inlet and the center of the circle.

FIG. 4 is a side elevation view of an apparatus for simultaneously detecting the eluates sprayed from multiple capillary liquid chromatography columns by a single mass spectrometer using a Hadamard sequence on each spray device;

FIG. 5 is a perspective view of a schematic representation of an arrangement of the spray devices in a circular format where the spray devices are connected to a planar separation device through capillaries;

FIG. 6 is a graph of a mass chromatogram TIC peak showing missing intensities during some time intervals obtained from the multiple-nozzle experiment as a result of Hadamard sequence application (the time bin's are superimposed over the peak);

FIG. 7 is a graph of the deconvoluted peak of FIG. 6;

FIG. 8 is a graph showing the peak in FIG. 6; however, the peak was obtained without the Hadamard sequence, i.e., the data were continuously acquired from a spray device without interruption;

FIG. 9 is graph of the deconvolution method which utilizes repeated Hadamard transforms on N data points;

FIG. 10 is a graph of a mass chromatogram of a peak obtained from a 7 spray devices experiment where the Hadamard sequence applied contained only one “0”; and

FIG. 11 is a graph of the deconvoluted peak of FIG. 10.

### DETAILED DESCRIPTION

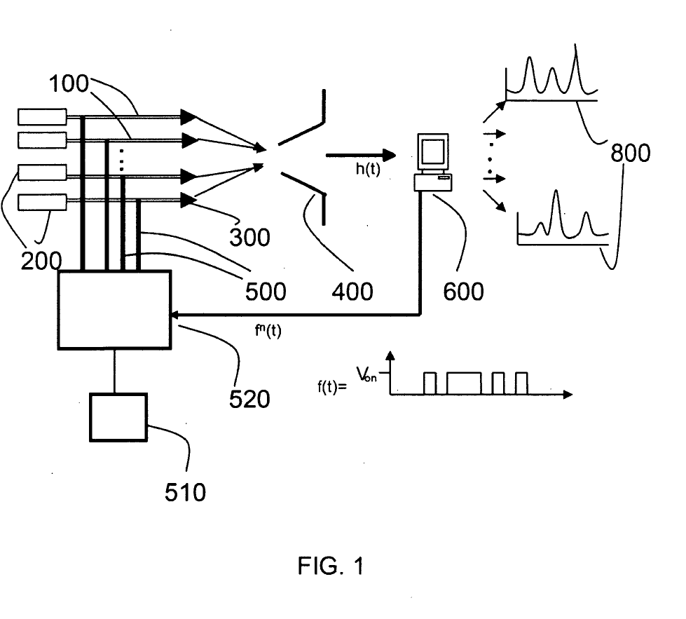

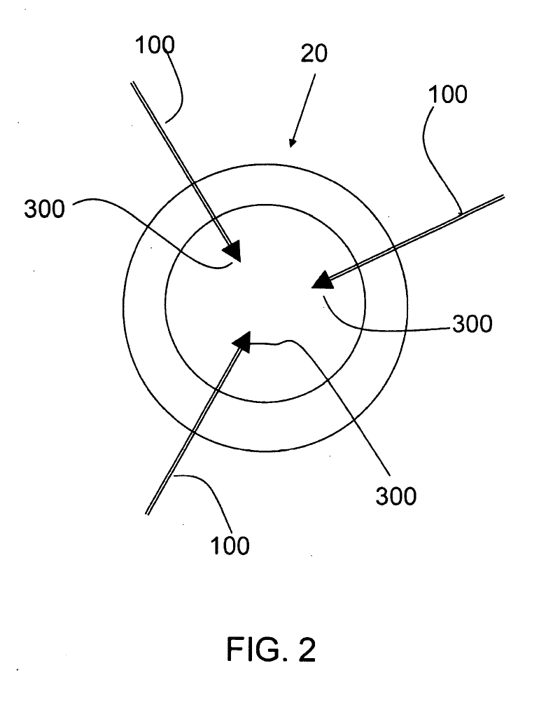

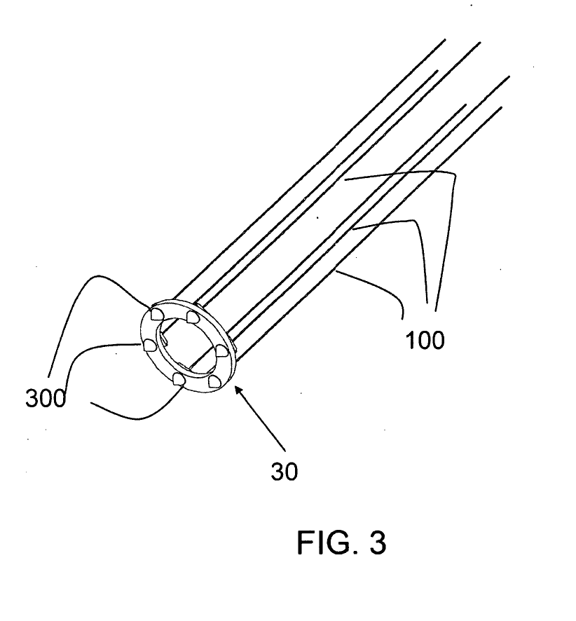

FIG. 1 depicts a typical configuration of the first embodiment of an apparatus in accordance with the present invention. An array of LC columns 100 is each connected to an LC pump 200 at the distal end and to a spray device 300 where the eluate emerges from the column and is sprayed into the mass spectrometer inlet 400. The spray devices 300 are preferred to be arranged in a circular pattern 20 as shown in FIG. 2. The mass spectrometer inlet is positioned on the axis through the center of the circle but a few millimeters away from the center of the circle. The spray devices 300 spray orthogonally into the mass spectrometer. The spray devices 300 should be arranged in such a way that no two spray devices 300 around the circle are placed along the same diameter of the circle. FIG. 3 shows another circular arrangement 30 of the spray devices 300 where the spray devices 300 are positioned axially with respect to the mass spectrometer inlet 400 as in FIG. 1. The angle between the spray devices 300 and the axial direction of the mass spectrometer inlet 400 may vary between 0 degree, as shown in FIG. 3, to 90 degrees, as shown in FIG. 2. If the LC method requires a flow rate that is higher than about 2 μL/minute, the eluate is split with a Tee-connection or a similar flow splitter well know in the art so that the resulted flow into the spray device is sufficiently low for unassisted electrostatically induced spray. Referring again to FIG. 1, the high voltage connection 500 for inducing the spray is applied to the spraying liquid through means well known in the art, e.g., either at the tip of the spray device or to the liquid from between the LC pump 200 and the spray device 300 through a liquid junction or a metallic connector. Depending on the kind of spray device 300 used, the voltage applied may be in the range of around 1 KV to around 5 KV. A high voltage power supply 510 provides the high voltage to the high voltage connection 500 via a bank of high voltage switches 520. The high voltage switches may be of any suitable kinds such as relays, transistor-based devices, etc. The high voltage switches 520 are in turn controlled by switches that can be turned on and off on a millisecond or shorter time scale by a computer program run by a computer or computer processor 600. The faster the on/off switching of the high voltage, the more time can the mass spectrometer have to collect data from the sprays. At the beginning of an LC-MS experiment, all the LC pumps 200 start the LC separations as programmed by the user. At the same time, the computer 600 executing the Hadamard sequence program begins applying the Hadamard sequence fⁿ(t) to the array of N spray devices 300 via the switches 520, where N is the dimension of the corresponding cyclic Hadamard S matrix. The time it takes the LC run from start T₀ to finish T_{end} is divided into equal time intervals called “time bins” t's. The length of tₙ should be small enough such that N time bins can fit into the width of an average peak, and preferably less than half of the peak width of the average peak in the mass chromatogram. The first time bin after T₀ is called t₁, and the second time interval after T₀ is called t₂, etc. until T_{end} when the experiment is finished. The T₀ and T_{end} are synchronized with the mass spectrometer data acquisition program such that every time interval in the mass chromatogram can be correlated to a tₙ in the LC run time. At T₀, the Hadamard sequence f¹(t) corresponding to a pattern of on's and off's of the high voltages is applied to the spray devices for the duration of the time bin t₁. During the time bin t₂, the second Hadamard sequence f²(t) is applied to the spray devices, etc. until at T_{end}, all the high voltages are turned off. The invention therefore involves applying the Hadamard sequence to samples that are unrelated and independent of one another. In all the prior art, each Hadamard sequence is applied to the same sample so that as time shifts on each injected segment of the sample occur as the sample traverses a distance from the point of injection, the sequence acts as the “barcode” for identifying the sample. In the present invention, the mass chromatogram h(t) obtained is a convolution of the mass peaks with fⁿ(t) obtained between T₀ and T_{end}, and h(t) is analyzed for the assignments of the peaks to the spray devices. Each chromatographic peak may appear to have missing signal in some time bins during which the spray device carrying the signal for the peak stopped to spray because the high voltage on that spray device was “off” in the Hadamard sequence, and at the same time, may have signal that contains sprays from more than one spray device. When deconvolution is applied to the peak in the mass chromatogram, the missing information in the peak from each spray device will be restored, and the signal from another spray device will be separated and be restored to the peak from the appropriate spray device. By processing every peak in the combined mass chromatogram h(t), the mass chromatogram 800 for the sample from each column is thus restored. This invention enables good signal to noise detection of chromatographic features from multiple samples simultaneously by a single mass spectrometer even when N=3.

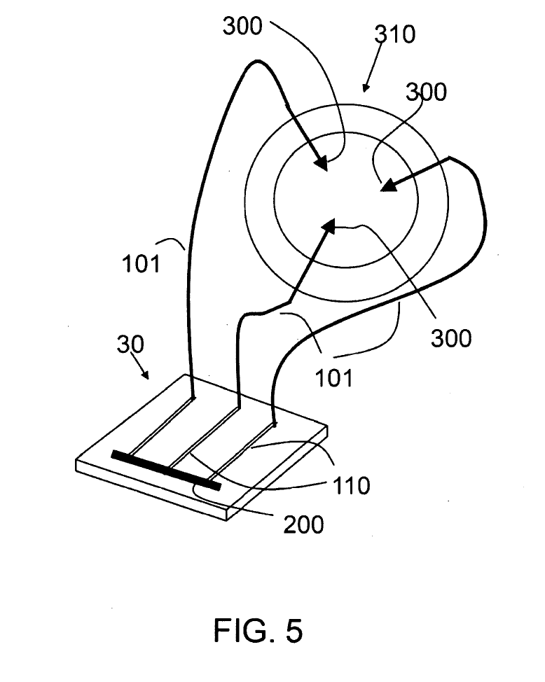

In the second embodiment of the invention, as illustrated in FIG. 5, in a multiple columns/multiple spray devices experiment as described above, a Hadamard pseudorandom sequence is applied to each spray device. The number of elements in the sequence is the same as the number of spray devices as long as the time required to apply the entire Hadamard sequence to the spray device is shorter than the width of an average chromatographic peak in the separation. The spray of the eluate is turned on or off according to the pseudorandom sequence, f^{j}(t). The convoluted function h(t) is the output of the mass spectrometer. This output is deconvoluted by the computer to restore the chromatogram 800 from the jth column as a function of time. This embodiment is the same as what is described in the first embodiment but the application of the Hadamard sequences to the spray devices is slightly different.

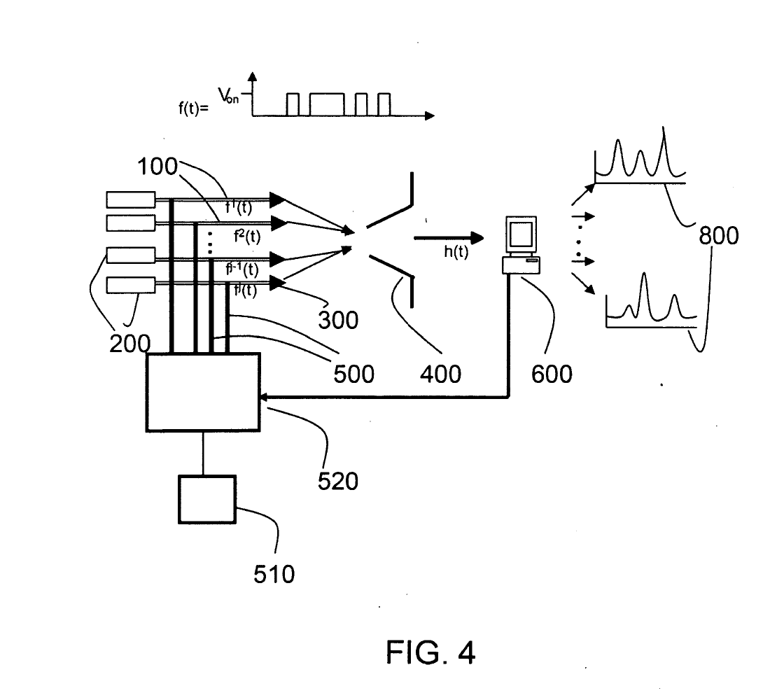

In still another embodiment of the invention, the spray devices 300 are connected through capillaries 101 to a planar microfluidic device 30 containing microfluidic LC columns 110 as shown in FIG. 4, or other forms of microfluidic separation devices. The application of the Hadamard sequences to the spray devices and the subsequent deconvolution is as described in the first embodiment.

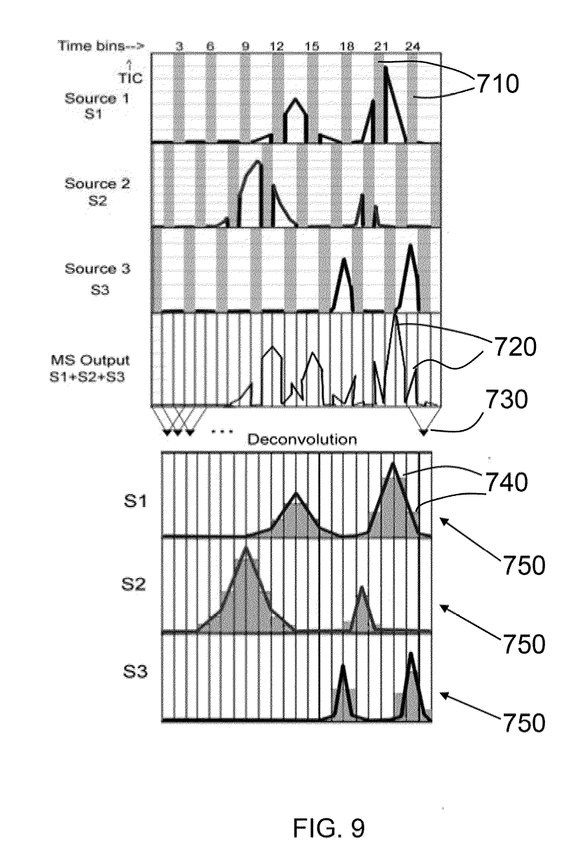

Still another embodiment of the invention is the deconvolution method, which is schematically represented in FIG. 9. According to this method for the case of N=3, the shaded portions 710 indicate intervals during which the spray of the nanospray source is turned off. Reading vertically for time bin=1, the Hadamard sequence representing the on/off pattern of the nanospray sources is 110. For time bin=2, the Hadamard sequence is 101, etc. The data 720 represented by the MS output are the sum of the 3 sources only two of which are on for a given time bin. Data points 730 are generated by averaging in each time bin. A transform of dimension N (N=3 in this case) is then carried out for each data point, utilizing N neighboring data points of which that data point is the central one. The result is approximate and relies on the time variation of the neighboring points being small. Errors caused by non-vanishing slopes and curvatures can be corrected exactly. Numerical simulations have shown that the de-convolution works well if the sharpest Gaussian peaks of the sources are at least N bins wide.

In FIG. 9, the deconvoluted signal is represented by the rectangular bars 740 at each time bin in the deconvoluted mass chromatograms 750. The signal from each source spraying separately and continuously is superimposed onto the deconvoluted signal to show the degree of approximation. It is clear from this diagram that the higher the number of time bins that fit into a peak, the better is the approximation.

This invention in this embodiment is not restricted to Hadamard sequences. For N spray devices, any set of N linearly independent on-off sequences can be used instead. For example, such a set can consist of sequences that contain only a single “off” state, i.e., a single “0” to be applied to the spray devices, with a distinct “off” state for each member of the set. Such a set would dramatically improve the duty cycle of data collection from about ½ to as much as (N−1)/N where N is the number of spray devices. The resolution of the chromatographic features is therefore also dramatically improved.

The embodiments of the invention described herein increases the sample throughput of LC-MS by at least 3 times and up to 10's of times more than the existing state-of-the-art even for complicated samples like blood serums. The invention here describes samples sprayed by nanospray, i.e., unassisted electrospray from a capillary column, but can be also be applied to conventional LC-MS, where the eluates from the columns should be split pre or post-column so as to achieve flow rates amenable to nanospray at the spray devices. It is also obvious to one skilled in the art that the embodiments of the invention which applies the Hadamard Transform to the spray devices may be combined with the prior art application of the Hadamard sequences to sample injection under some conditions.

### Example 1

The spray device N₁, N₂ and N₃ arranged in a circle in a configuration similar to that shown in FIG. 2 were spraying from the ends of three separate columns separating 3 different samples, each having unknown components which may be identical to those in the other one or two, or may be completely different. The sprays were collected by the mass spectrometer whose inlet cone was positioned on the axis through the center of the inlet cone and the center of the spray devices circle. The eluate coming out of each column was sprayed from the nozzle by turning the high voltage on the nozzles on and off according to the following patterns:

### T_{n →}

### N₁: 011011011011011011011

### N₂: 110110110110110110110

### N₃: 101101101101101101101

The cyclic Hadamard S matrix is a N=3 dimensional matrix as follows:

$$( \begin{matrix}0 & 1 & 1 \\ 1 & 1 & 0 \\ 1 & 0 & 1\end{matrix} )$$

This series of on/off sequences was repeated for each time interval Tₙ until the end of the experiment.

The signal recorded by the mass spectrometer vs. time was the total ion current (TIC) trace. The TIC represented all the ions detected by the mass spectrometer at any given time. The TIC could be further broken down into the masses of the ions collected into the TIC. In this well designed chromatographic experiment, the components were “base-line” separated so that each peak in the TIC trace represented the ions collected from a single mass species. If the peak contained masses from two species or more, the components were said to have co-eluted.

In this experiment, the “on” time interval was 2 s and the “off” time interval is 0.5 s. During the off time, the eluate coming out of the nozzle accumulated into a small bubble, which sprayed off into the mass spectrometer when the high voltage was on again. In the TIC vs. Time trace, a small burst of signal might appear. The 2.5 s of time did not create any bubble of substantial size in this experiment. The components in each column were carried along by a run buffer which was made of water+1% acetic acid (A) and methanol (B) in a gradient elution program from 90% B to 90% A varying linearly over 40 minutes. The run buffer was pumped pneumatically but in other cases, might also be pumped electrokinetically. The mass spectrometer's mass range for detection was chosen so that the low molecular weight solvent was not recorded by the mass spectrometer. The signal in a peak is pre-dominantly related to a component of the sample.

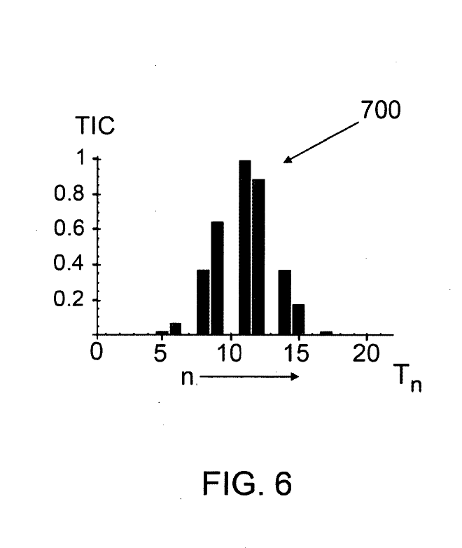

A peak appeared in the trace at T₅ as shown in FIG. 6. The full width of the peak was 30 s. The time bins for the spray devices' on/off were overlaid on the peak. During the duration of the peak, high voltage on/off patterns occurred. Just before and just after the peak the on/off patterns were known as follows:

| time | On/off pattern fⁿ(t) | TIC signal, BL = baseline |
|---|---|---|
| T₅ | 110 | >BL |
| T₆ | 101 | >BL |
| T₇ | 011 | =BL |
| T₈ | 110 | >BL |
| T₉ | 101 | >BL |
| T₁₀ | 011 | =BL |
| T₁₁ | 110 | >BL |
| Etc. | | |

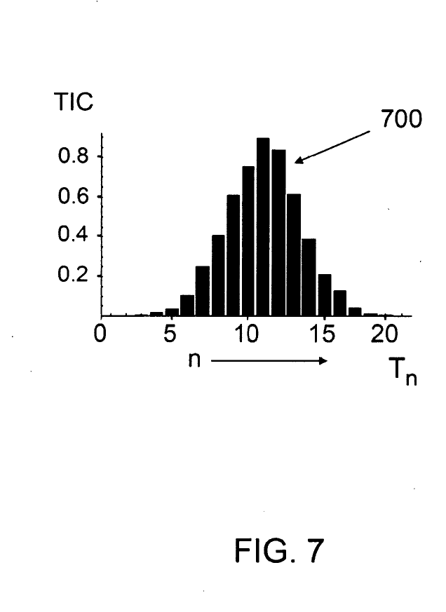

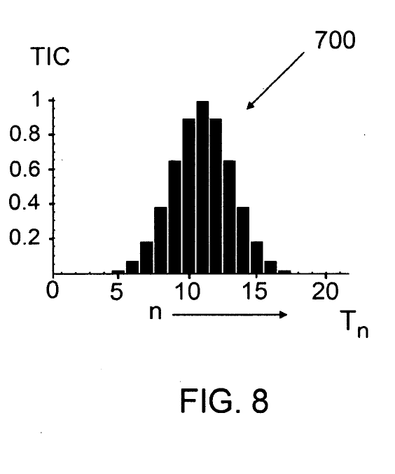

By analyzing the signal and correlating with the high voltage on/off pattern, it was clear that the peak most likely came from N₁. There were 8 data points collected across the peak. If the experiment had been conducted by spraying the nozzle one after another, only 4 data points across the peak would have been collected. The peak was a lot better defined by 8 points instead of 4. By applying the deconvolution routine to the data, the peak 700 was restored, as shown in FIG. 7. The peak that had been obtained with a single spray device spraying continuously is shown in FIG. 8 for comparison. The deconvoluted peak was a few percent smaller in height and wider in width. Further data processing would produce a deconvoluted peak that would be even closer to the peak obtained with a single spray device.

This example serves to illustrate the simplest utility of the invention, but the invention can be used on far more complicated chromatograms where there may not be any obvious missing pieces in a peak because of overlapping peaks from different sprayers.

According to the conventional application of Hadamard Transform, an experiment with just three spray devices (N=3 in the detailed description of the invention section), not much signal improvement should have been expected since the signal improvement was expected to be at most the square root of N divided by 2. This invention increases the duty cycle for data collection thereby improving the appearance of the peak. The same procedure can be extended to larger number of spray devices and columns.

### Example 2

The experiment in Example 1 was repeated using 7 spray devices, S₁, S₂ . . . S₇ connected to 7 separation columns. The eluate coming out of each column was sprayed from the nozzle by turning the high voltage on the nozzles on and off according to the following patterns:

### T_{n →}

### S₁: 111111011111101111110 . . .

### S₂: 111110111111011111101 . . .

### S₃: 111101111110111111011 . . .

### S₇: 011111101111110111111 . . .

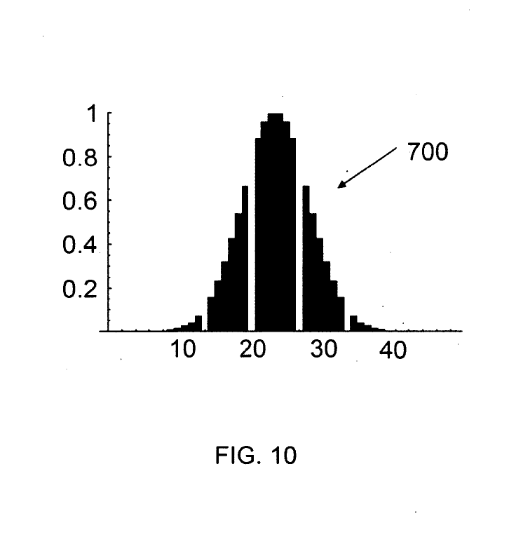

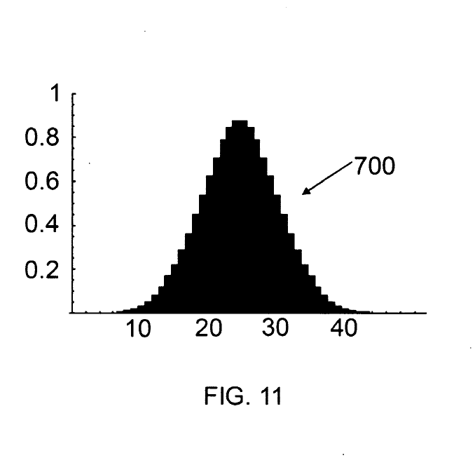

During any one time bin, there was only a single spray device that was in the “off” state. FIG. 10 shows a chromatographic peak 700 that was obtained using these sequences. FIG. 11 shows the deconvoluted peak 700 that was restored with the method described in FIG. 9. Even when two peaks of the same masses overlap substantially from two different spray devices, the peaks could be restored and assigned to the correct spray device with this method.

The present invention enables higher throughput of sample to mass spectrometer detection for liquid chromatography-mass spectrometry experiments.

It will be appreciated by persons skilled in the art that the present invention is not limited to the embodiments described thus far with reference to the accompanying drawings; rather the present invention is limited only by the following claims.

What is claimed is:

1. A system to increase throughput of a liquid chromatography-mass spectrometry technique comprising:
a liquid chromatography apparatus that includes plurality of sample spray devices each of which is connected to a corresponding plurality of liquid chromatography (LC) column, each spray device being associated with one LC column that runs a particular separation of a sample; and
a source of electricity operably connected to each spray device for controllably inducing a spray from each sample spray devices, the source including an electrical circuit that can generate a high voltage between about 1 KV and about 5 KV and turn the voltage on and off at discrete times, the circuit being controlled by a computer that includes software that is configured to instruct the high voltage to be applied to each spray device in accordance with a unique Hadamard sequence that defines an on/off spray pattern of each spray device;
wherein the spray devices are positioned such that tips thereof are aimed at a mass spectrometer inlet of a mass spectrometer component which collects the sprays from the spray devices and during any particular time interval during of the mass spectrometer, an exact on-off spray pattern of each spray device is known and tracked.

2. The system of claim 1, wherein the spray devices are arranged in a circle or an arc of a circle around the inlet of a mass spectrometer.

3. The system of claim 1, wherein a number of samples that can be detected by a single mass spectrometer at any time is equal to the number of spray devices.

4. The system of claim 1, wherein the software is configured to assign any mass chromatographic peak in the mass chromatograph that records all peaks eluting from all of the LC columns to the LC column from which it elutes and thus to a sample contained in the column of which it is a component.

5. The system of claim 1, wherein the computer executes a Hadamard sequence program and applies the Hadamard sequence to the plurality of spray devices.

6. The system of claim 1, wherein a time it takes for the liquid chromatograph to run from a start time T₀ a finish time T_{end} is divided into equal time intervals (tₙ), the mass chromatograph outputting a mass chromatogram h(t) that is a convolution of the mass peaks with fⁿ(t) obtained between T₀ and T_{end} and h(t) is analyzed for the assignments of the peaks to the spray devices.

7. A method for increasing throughput of a liquid chromatography-mass spectrometry technique that includes a plurality of sample spray devices that are fluidly connected to a plurality of liquid chromatograph (LC) columns that each holds a sample having unknown components comprising the steps of:
arranging the plurality of spray devices such that tips thereof are aimed at a mass spectrometer inlet that collects sprays from the plurality of spray devices;
applying a high voltage between about 1 KV and about 5 KV to the spray devices to cause eluate coming out of each LC column to be sprayed from the respective spray device, wherein the high voltage applied to each spray device is applied in accordance with a Hadamard sequence that defines an on/off spray pattern of each spray device, wherein the Hadamard sequences for the spray devices is repeated for each time interval Tₙ;
analyzing signal data that is recoded by the mass spectrometer in the form of a mass chromatogram and correlating with the high voltage on/off spray pattern to determine from which spray device a particular measured peak is derived; and
applying a deconvolution routine to the data to restore the measured peak.

8. The method of claim 7, wherein the signal data recorded by the mass spectrometer vs. time comprises a total ion content (TIC) trace that represents all ions detected by the mass spectrometer at any given time.

9. The method of claim 8, further comprising the step of:
base-line separating the components such that each peak in the TIC trace represents the ions collected from a single mass species, wherein the signal in a peak is pre-dominantly related to a component of the sample.

10. The method of claim 7, wherein the step of analyzing signal data includes the step of overlaying time bins for the spray devices' on/off spray patterns on the measured peak.

11. The method of claim 7, wherein the step of applying a deconvolution routine to a measured peak, a shape and intensity of the peak is stored to resemble the peak that would have been obtained from a single LC column the eluate of which is sprayed into the mass spectrometer continuously.

12. The method of claim 7, further including the step of:
dividing a time it takes for the liquid chromatograph to run from a start time T₀ a finish time T_{end} into equal time intervals (tₙ), wherein the mass chromatogram h(t) obtained is a convolution of the mass peaks with fⁿ(t) obtained between T₀ and T_{end} and the step of analyzing the data comprises the step of analyzing the mass chromatogram h(t) for the assignments of the peaks to the spray devices.

13. The method of claim 7, wherein the deconvolution routine is applied to a peak in the mass chromatograph to restore missing information in the peak from each spray device and separating a signal from another spray device and restoring the signal to the peak from an appropriate spray device.
